(19) United States
(12) Patent Application Publication
(10) Pub. No.: US 2007/0205330 A1
(43) Pub. Date: Sep. 6, 2007

(54) Flight/launch vehicle and method using internally stored air for air-breathing engines

(75) Inventor: Douglas Wayne Hubbard, Glen Ellyn, IL (US)

Correspondence Address: Tomas Friend, LLC, 694 Cherry Tree Rd., Gurley, AL, 35748, US

(73) Assignee: Hubbard Aerospace, LLC, Glen Ellyn, IL (US)

(21) Appl. No.: 11/330,018

(22) Filed: Jan. 11, 2006

(51) Int. Cl. B64G 1/40

(52) U.S. Cl. 244/171.1

(57) ABSTRACT

An airship is disclosed that stores air and uses it in a propulsion system that requires oxygen. This allows the airship to travel above the atmosphere, where oxygen is not available. The airship maximizes known mature technologies such as the buoyancy of a lighter than air balloon and the aerodynamic lift and propulsion of an airplane, until the altitude renders these technologies ineffective. The modified airship uses the stored air to extend transportation operations above natural limits and permit high-speed travel beyond traditional atmospheric speeds. Entering the edge of space at high tangential velocity permits placement of payloads into orbit. Entering the edge of space at low tangential velocity presents opportunities for low energy plane changes in orbital inclination. The modified airship may also alter the aerodynamic shape as desired in flight. The airship takes off, leaves and re-enters the atmosphere and lands without specialized launch facilities or long landing strips. The reusable vehicle provides transportation services from point to point on the earth surface and from the earth to points in space.

### CROSS-REFERENCE TO RELATED APPLICATIONS

Not Applicable

### STATEMENT REGARDING FEDERALLY SPONSORED RESEARCH OR DEVELOPMENT

No government funding or support is related to this invention.

### INCORPORATED-BY-REFERENCE OF MATERIAL ON A CD

Not Applicable

### BACKGROUND OF THE INVENTION

1. Field of the Invention

The present invention relates to vehicles capable of operating in the atmosphere and above it. More specifically, the invention is a vehicle that uses air-breathing engines to collect and pressurize atmospheric air within a flexible air envelope and subsequently uses the stored air as an oxidizer for the same engines during flight above the atmosphere. The vehicle may be designed to operate as a dirigible in the lower atmosphere, an airplane in the upper atmosphere, and an air breathing rocket above the atmosphere or may operate as an airplane both in the upper and lower atmosphere and as an air-breathing rocket above the atmosphere. The modified airship can be used for ground to ground transportation services through atmospheric, transatmospheric, or suborbital flight or for ground to space transportation by providing a reusable, suborbital launch vehicle that serves as a first stage for spacecraft or achieves low earth orbit itself.

2. Description of Related Art

A variety of vehicles have been designed that aim to provide ground to space transport at lower cost than the space shuttle and conventional rockets. Similarly, a number of vehicles have been designed to provide supersonic ground to ground transport through suborbital flight. A number of organizations have cooperated in various programs with the U.S. government to spend approximately $10 billion to explore various transportation to orbit and suborbital flight concepts. As of this filing, the need for affordable transportation to orbit and supersonic suborbital transport remains. The present invention provides a modified lifting body/airship design and method that satisfies the aforementioned need. One of the key elements of the modified lifting body/airship is its ability to store air collected using air-breathing engines during flight for use by the very same air breathing engines so that the lifting body/airship can achieve transatmospheric, supersonic suborbital, or even low earth orbit flight.

U.S. Pat. Nos. 6,119,983 and 6,357,700 to Provitola, disclose inventions that can be described as airships/spaceships that provide earth to orbit transport. The principle behind both inventions is to attain the highest possible altitude before using rocket engines for transatmospheric flight. Lifting gas is used to provide buoyant lift in the lower atmosphere and some of the lifting gas (hydrogen) is burned in air-breathing engines, reducing the density of the lifting gas and prolonging buoyancy. The aim is to attain maximum possible altitude before switching to non air-breathing rocket engines. The '700 patent discloses electric engines powered by microwaves from ground-based locations and supplying stored air to electric engines that superheat the air for thrust. The Provitola patents do not disclose or suggest using air-breathing engines to collect external air for subsequent use by air-breathing engines above the atmosphere or the diversion of external air into a flexible air envelope.

U.S. Pat. No. 6,471,159. to Bundo, entitled “AIRSHIP SHAPED SPACE CRAFT,” discloses an airship using jet engines and rockets. The '159 Patent discloses an airship shaped spacecraft switching between jet engines and rockets depending on whether the craft is in the atmosphere or in a vacuum environment. It does not disclose the storage of air to operate jet engines in a vacuum or near vacuum environment above the atmosphere.

U.S. Pat. No. 6,196,498, to Eichstedt, et al., entitled, “SEMI-BUOYANT VEHICLE WITH AERODYNAMIC LIFT CAPABILITY,” discloses a non-ridged, semi-buoyant aircraft comprising a pressure stabilized gasbag having front and rear ends and an aerodynamic shape capable of producing lift for the transportation vehicle. The '498 Patent is not fully buoyant and uses a propeller to move its aerodynamic shape through the atmosphere near earth. The '498 Patent does not use stored air as part of a system for feeding air-breathing engines above the atmosphere. The '498 Patent does not use air collected during flight for any purpose of ballast or controlling buoyancy but does use outside air for air-breathing engines used to drive propellers for atmospheric flight. The '498 Patent does mention using aerodynamic lift capability similar to a fixed wing aircraft but does not disclose altering the aerodynamic shape of the vehicle by any method. The invention disclosed in the '498 Patent is limited to air travel in the atmosphere and is not intended for travel above the atmosphere.

U.S. Pat. No. 4,012,016 to Davenport, entitled “AUTONOMOUS VARIABLE DENSITY AIRCRAFT” discloses a variable density aircraft with a gas cell, or collapsible hinged panel hull which causes a densemetric variation in the aircraft. The '016 Patent does not disclose using stored air for air-breathing engines in trans-atmospheric flight and the gas in the gas cell is not used as a propellant for trans-atmospheric flight. The invention disclosed in the '016 Patent is limited to air travel in the atmosphere and is not intended for travel above the atmosphere.

U.S. Pat. No. 4,052,025 to Clark, et al., entitled “SEMI-BUOYANT AIRCRAFT” discloses a semi-buoyant lift-augmented aircraft of immense size, which includes a fuselage of airfoil shape formed by a rigid geodesic type web framework enclosing buoyant cells pressurized to reinforce the framework. The '025 Patent is an airship not capable of or intended for transatmospheric or supersonic flight. The '025 aircraft does not store air for use by air-breathing engines outside of the atmosphere.

### BRIEF SUMMARY OF THE INVENTION

In one aspect, the invention is a reusable launch vehicle that is nearly or somewhat buoyant at low altitudes, maintains or transitions to using aerodynamic lift as it ascends to higher altitudes, inhales air into a storage container, and ultimately operates as an air breathing rocket above the atmosphere by exhaling internally stored air through air-breathing engines. The vehicle uses the reverse process for returning to the ground, flying as an airplane at high altitudes and transitioning to buoyant, or nearly buoyant, airship or lifting body flight at lower altitudes. While the vehicle is at its maximum altitude, an expendable second stage can be used to carry payloads into earth orbit and beyond. Alternatively, the vehicle can be configured to achieve low earth orbit itself. The vehicle uses its internal volume to store air collected during ascent for subsequent use as the oxidizer for air breathing engines above the atmosphere. Unique vehicle features include: the use of air-breathing engines (engines that use air as an oxidizer for combustion) to force outside air into a flexible air envelope; the subsequent use of the stored air by the air-breathing engines; the large volume, lifting body airship design capable of storing substantial amounts of air for air-breathing engines; and force feeding pressurized, stored air to air-breathing engines to achieve supersonic flight without exposing the engines to supersonic input of air. If the flexible air envelope is filled with lifting gas at low altitude, the craft may be operated as an airship, allowing for flexible launch and landing operations at near zero buoyancy. Building the craft requires no new technologies and therefore provides a high margin of safety, maximum recoverable launch value, and virtually unlimited scale-up capacity. The Air-Breathing Lung Reusable Launch Vehicle (ABL-RLV) can operate with either a high tangential velocity like most rockets entering orbital insertion or a low tangential velocity much like a sounding rocket providing an opportunity for a low energy plane change.

In another aspect, the present invention is a high speed ground to ground transport vehicle that flies at subsonic speeds in the atmosphere and supersonic speed above the atmosphere using air breathing engines and compressed air stored in the vehicle.

In yet another aspect, the present invention is a method for delivering payloads into earth orbit and into space by flying at subsonic speeds in the atmosphere and supersonic speed above the atmosphere using air breathing engines and compressed air stored in the vehicle.

In yet another aspect, the present invention is a method for the rapid delivering payloads from one location on earth to another by flying at subsonic speeds in the atmosphere and supersonic speed above the atmosphere using air breathing engines and compressed air stored in the vehicle.

### BRIEF DESCRIPTION OF THE SEVERAL VIEWS OF THE DRAWINGS

The accompanying drawings, which are incorporated into and form a part of the specification, illustrate several embodiments of the present invention and, together with the description, serve to explain the principles of the invention. The drawings are only for the purpose of illustrating preferred embodiments of the invention and are not to be construed as limiting the invention, which can be practiced in many variations without departing from the spirit or scope of the invention.

FIG. 1 schematically depicts one embodiment of a near zero buoyant reusable launch vehicle that uses its internal volume to store air collected during ascent as an oxidizer during near vacuum operation.

FIG. 2 shows one embodiment of a small scale airship launch vehicle.

FIG. 3A-C provides side, front, and bottom views of the embodiment shown in FIG. 2.

FIG. 4 is a side cross section of a craft having the dimensions as shown in FIG. 3.

FIG. 5 illustrates the airflow patterns during three different modes of operation.

FIGS. 6A and B is a schematic of the side and bottom views of a large orbital airship launch vehicle of the present invention.

FIG. 7 is an artists rendering of a large ABL-RLV.

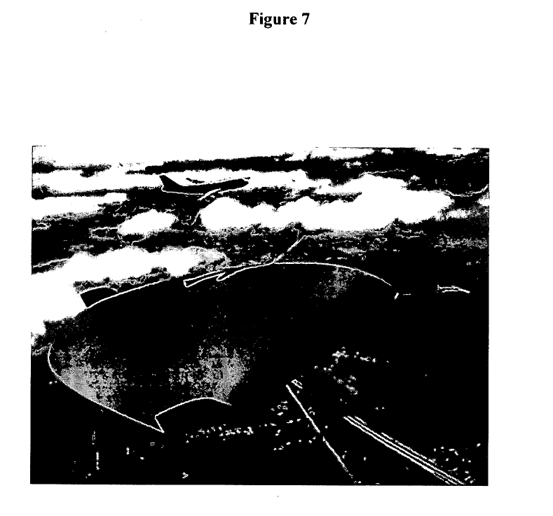

### DETAILED DESCRIPTION OF THE INVENTION

The Air-Breathing Lung Reusable Launch Vehicle (ABL-RLV) can be described as a type of modified airship that is capable of transitioning from lighter than air flight to aerodynamic lift flight and ballistic flight. The craft need not, however, be buoyant in all embodiments and, in some embodiments, may be heavier than air at all times and use lifting body forces for flight while in the atmosphere. The exterior skin of the craft forms a flexible air envelope in the shape of a lifting body and forward motion of the craft can be used for ascent even at sea level. The embodiments described in the figures involve the use of lifting gasses for buoyancy to illustrate advantages such as independence from large runways or other launch facilities.

The ABL-RLV represents a novel form of flight hardware made possible in part by the realizations that: 1) the large volume of an airship can be used to store air that can be used by air breathing engines above the atmosphere, 2) the large size of the airship does not lead to high drag at very high altitudes, 3) the shape of the airship can be designed for aerodynamic lift, 4) the airship can transition from lighter than air flight to aerodynamic lift flight at high altitudes where drag is reduced, 5) during the transition from lighter than air to aerodynamic lift flight, lifting gas can be replaced by air for use in air breathing engines, 6) there is an advantage to using internally stored air for air-breathing engines at supersonic speeds because the air entering the engines travels at subsonic speeds, and 6) a large airship reentering into the earth's atmosphere experiences lower temperatures than current spacecraft because of a high surface area to weight ratio.

The ABL-RLV does not use lifting gas as a propellant. Instead, it vents lifting gas to make room available for air it collects while in flight. This is made possible by one or more by-pass flow thrust diverters on the air-breathing engines and a dual containment system that holds lifting gas in flexible bladders within a larger, less flexible air envelope that surrounds the majority of the volume of the craft. A minimal internal positive pressure is maintained to support and control the shape of the outer skin of the craft. The internal pressure may be twice the external atmospheric pressure or higher when the flexible air envelope is full to maximize the amount of air available for transatmospheric flight. The fuel for the engines may be a liquid, such has liquid hydrogen, methane, liquefied propane, or jet fuel and the engines are conventional air-breathing engines that use air as an oxidizer for combustion.

During flight, the ABL-RLV reduces buoyancy by venting lifting gas. As the lifting gas is vented, the volume of lifting cells holding the lifting gas is reduced. The lifting cells lie within the flexible air envelope forming the outer shell of the craft. As the volume of the lifting cells decreases, the volume of air in the flexible air envelope increases by drawing air in through an air inlet in fluid communication with the interior of the flexible air envelope. As the replacement of lifting gas by air causes the craft to become heavier, it relies more on its wing-shaped body and forward motion to remain aloft. Once the craft has reached an altitude lacking sufficient oxygen for the operation of its engines, the engines are supplied with stored air that allows the craft to fly above the atmosphere. As stored air is consumed, the lifting cells are refilled with lifting gas to maintain internal pressure for structural support.

The ABL-RLV accomplishes the exchange of lifting gas for air during ascent and air for lifting gas during descent using a dual containment system. The system uses flexible internal bladders (lifting cells) for lifting gas contained within a flexible air envelope that forms the surface of the craft. As the lifting gas is vented from the lifting cells, air is drawn into the flexible air envelope, displacing the volume lost from the lifting cells, and maintaining internal pressure. This air is collected and pressurized for storage by by-pass flow thrust diverters on the same engines that subsequently use the stored air for operation at altitudes well above their normal operating limits. When the engines draw on the stored air, the lifting cells are refilled to maintain pressure within the air envelope. This allows the craft to alternate between filling itself with lifting gas and collected air as required in the trajectory of the vehicle while maintaining a minimal interior pressure to support the craft's outer surface.

The only rigid component of the ABL-RLV is the keel, which extends from the nose of vehicle along the bottom of the vehicle and may be up to 60% of the length of the entire vehicle. This keel has the function of transferring some of the load from dynamic pressure on the nose. It also provides hard points on which to attach tanks, propulsion, payload storage, heat exchangers, and other systems. Load is distributed along the keel and the keel is supported at several points by suspension cables from the top of the envelope. Some of the structural requirements can be simplified by virtue of the fact that there is always a relatively high positive internal pressure maintaining the integrity of the shape.

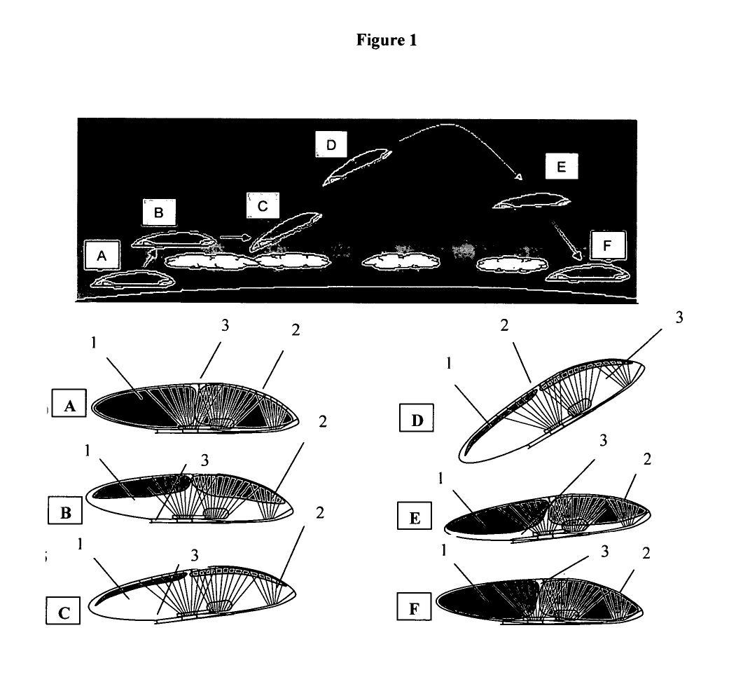

FIG. 1 schematically depicts one embodiment and mode of operation of an ABL-RLV using its internal volume to store air collected during ascent as an oxidizer during near vacuum operation. A) Near sea level, flexible, internal bladders (“lifting cells”) 1 are full of a lifting gas such as hydrogen or helium. The craft is lighter than air and controls like an airship using outside air and one or more jet engines as maneuvering propulsion for traveling to cruise altitude. B) The craft moves to a cruise altitude of approximately 9-12 km and begins to vent lifting gas while filling the internal air containment space 3 inside the flexible air envelope with cold, dense air by diverting some of the bypass of turbofan engines. As the airspace “lung” fills with air, hydrogen gas in the lifting cells is displaced while a minimum positive pressure is maintained inside the flexible air envelope 2. The craft gradually loses buoyancy and eventually relies entirely on aerodynamic lift to stay airborne. In this embodiment, hydrogen from heat exchangers is used as fuel for the engines. C) After 30 to 60 minutes at cruise altitude, the “lung” is full and the lifting cells are almost entirely empty. At this point, the craft transitions into a full powered ascent, initially using external air for the engines. D) At the limits of the performance envelope of the engines, the engines are switched to using air stored in the “lung.” By the time the craft reaches supersonic speed, the air density is so low that the drag experienced by the large vehicle is not a significant problem. This portion of the flight is ballistic and takes the craft far above the atmosphere, as high as low earth orbit. At this stage, the empty lifting cells 1 and flexible air envelope 2 are nearly at a vacuum but at higher pressure than the exterior of the vessel. E) When the craft reenters the atmosphere, the total kinetic energy is per unit area is a small fraction of that for current reentry vehicles and peak temperatures are within the performance limits of advanced fabrics used on the flexible air envelope 2 of the craft. The leading edges are also cooled by liquid hydrogen, which boils and partially refills the lifting cells. The lifting cells in the flexible air envelope fill with hydrogen to atmospheric pressure and the engines operate using outside air. F) When the craft reaches cruise altitude, it is moving at subsonic speed and is buoyant. The lifting cells need not be as full as they were during take off because fuel consumption has reduced the mass of the craft. The craft controls as an airship to its destination. FIG. 1 represents a ground to ground transport mission. For a ground to space transport mission, the craft would carry a payload with propulsion capability that would carry the payload from the highest altitude achieved by the craft into earth orbit or beyond.

The dimensions and precise configuration a given ABL-RLV will depend on the intended use of the vehicle. Three representative embodiments with some of their corresponding specifications are shown in Table 1. Those skilled in the art will appreciate that vehicles having dimensions and specifications differing form those below are possible and included within the scope of the invention.

TABLE 1
Three Sizes of ABL-RLVs with Specifications

| | Large | | Intermediate | | Micro-UAV | |
|---|---|---|---|---|---|---|
| Length | 270 | meters | 140 | meters | 13.3 | meters |
| Dry weight | 862,000 | kg | 162,000 | kg | 164 | kg |
| Payload on sub-orbital hop | 250,000 | kg | 48,000 | kg | 25 | kg |
| LEO Payload w/expendable upper stage | 165,000 | kg | 25,000 | kg | 6 | kg |
| Neutral buoyant altitude w/empty lungs | 950 | m | 60 | m | 20 | m |
| Internal lung air capacity when full | 4,300,000 | kg | 540,000 | kg | 387 | kg |
| Maximum overpressure of envelope | 0.7 | atm | 0.7 | atm | 0.6 | atm |
| Air density in lungs | 2.46 | kg/m³ | 2.24 | kg/m³ | 1.96 | kg/m³ |
| Air temperature in lungs | 120 | K | 135 | K | 135 | K |
| Maximum velocity | 6,000 | m/s | 5,000 | m/s | 3,300 | m/s |
| Range of one sub-orbital hop | 9,000 | km | 6,500 | km | 2,200 | km |
| Envelope thickness (advanced fabric) | 2 | mm | 1 | mm | 0.7 | mm |

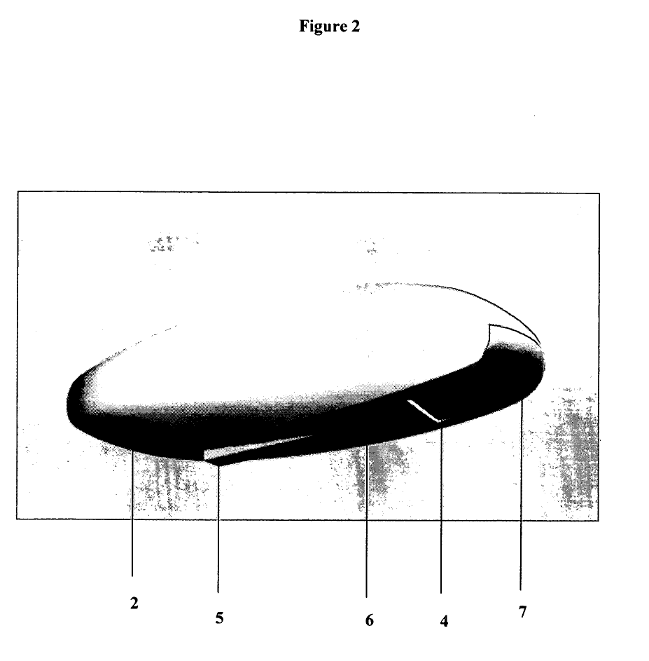

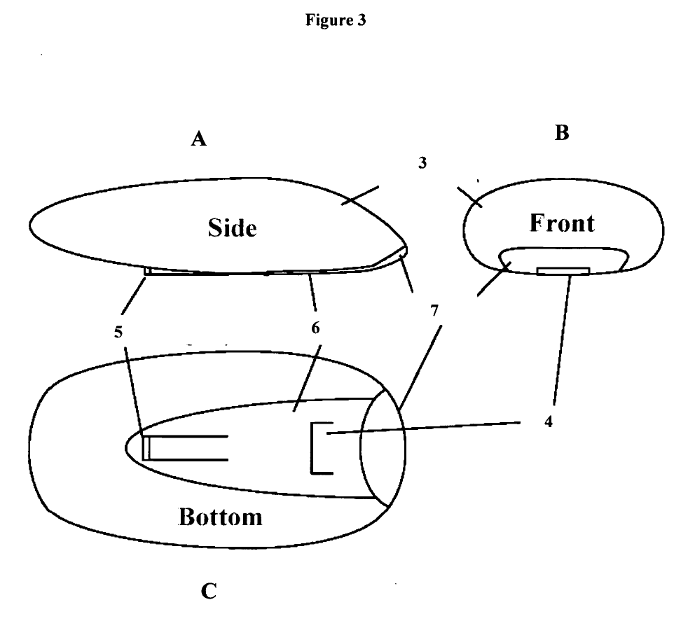

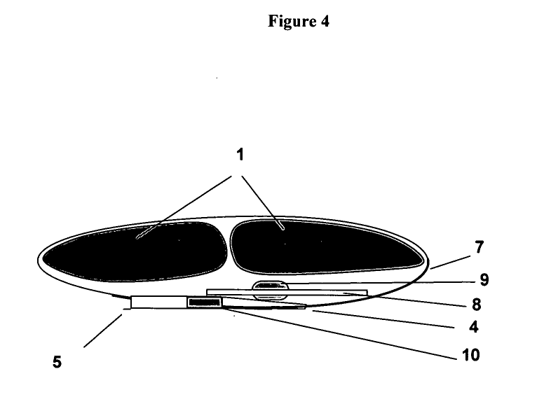

FIG. 2. shows an embodiment of a small, unmanned ABL-RLV flying at cruising altitude. Air inlet 4 is open to allow internal air storage. The interior of the flight vehicle is defined by the flexible air envelope 2 and the rigid keel 6, which are joined in an airtight manner. FIG. 3A-C provides side, front, and bottom views of the embodiment shown in FIG. 2. The flexible air envelope 2 forms the skin of the craft above the rigid keel 6. Rigid keel 6 has a nose 7 with an increased thermal protection system (TPS) for re-entry and is located at the forward edge of rigid keel 6. Rigid keel 6 also contains air inlet 4, which draws outside air into the complete volume of the flexible air envelope 2 and thrust vectoring flaps 5, which are used to propel and maneuver the flight vehicle. This particular embodiment is 3.1 meters tall, 6.2 meters wide, and 12 meters long. The keel is 3.1 meters wide and 9.9 meters long. Rigid keel 6, flexible air envelope 2 and subsystems can vary with the size, application and payload of flight vehicle. FIG. 4 shows an embodiment having the same dimensions as the craft in FIG. 3. Shown are hydrogen lifting cells 1, air inlet 4, thrust vectoring flaps 5, rigid nose 7, heat exchangers 8, methane fuel tank 9, and EJ-22 Turbofan engine 10.

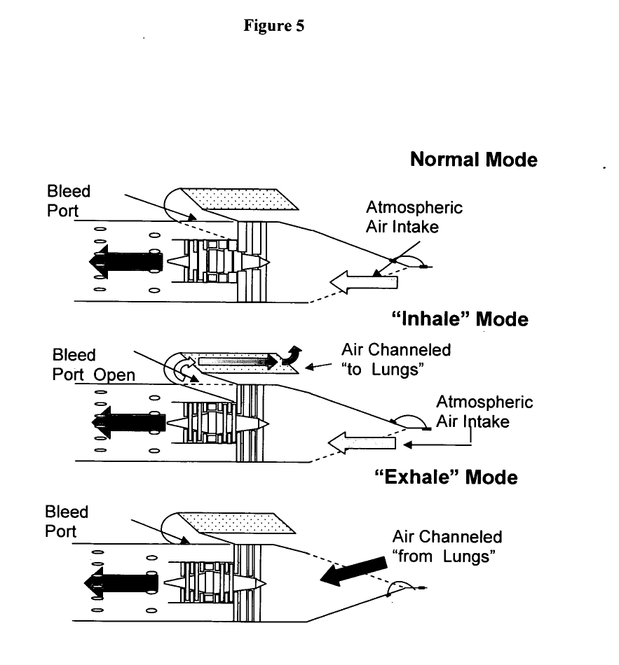

FIG. 5 illustrates the airflow patterns during three different modes of operation. During normal operation, the air inlet is open to provide air for the engines. The thrust diverter is closed and the turbofan engine operates normally, burning a lean hydrogen mix. During the “inhale” mode the air inlet and thrust diverter are both open to direct bypass flow of air through the heat exchangers and into the volume of the flexible air envelope. During “exhale” mode, the air inlet and thrust diverter are both closed and the engines are provided with cold, pressurized air from volume of the flexible air envelope to operate with maximum thrust.

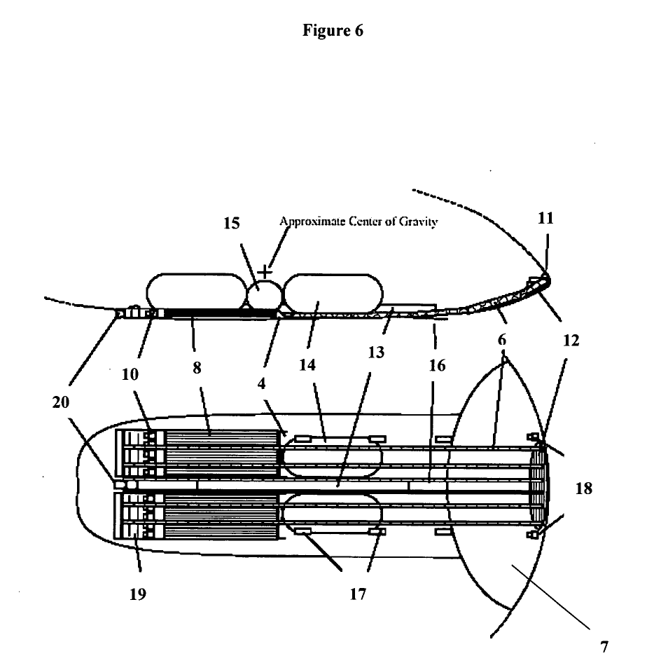

FIGS. 6A and B represent a conceptual schematic of the internal system layout of the Keel in one embodiment of a ABL-RLV. Flexible air envelope 2 is made from heat resistant materials and contains internal bracing including controllable struts and air beams to maintain the aerodynamic lifting shape and lifting gas cells 1 to store lifting gas for buoyancy. Rigid keel 6 contains a cockpit 11 joined with one or more passenger compartment modules. Leading edge heat exchangers 12 are located near nose 7 and provide cooling for the leading edges of the flight vehicle. Rigid keel 6 also supports the cockpit 11, passenger compartment, payload bay 13, liquid hydrogen tank 14, liquid oxygen (LOX) tank 15, loading ramp 16, landing gear wells 17, forward maneuvering engines 18, heat exchanger 12, jet engine 10, after burner 19, rocket engines 20 and other mass to be transported.

The performance of the ABL-RLV can be improved through several modifications. For example, chilling of the stored air and/or carrying some liquid oxidizer in addition to the liquid fuel can improve mass ratios. By augmenting the air with liquid oxidizer the specific impulse for LOX/air/LH2 will be at least 230. Enriching the oxygen content of stored air can be achieved with various oxygen enrichment techniques including air-separation methods with membranes, LOX gasification, and/or ionizing the air to generate ozone. One or more rocket engines may be used for example, for maneuvering in space.

Altering the aerodynamic lift shape of the vehicle during flight is also contemplated as a means of optimizing performance at different stages of flight. This can be accomplished using variable pressure in two or more existing internal flexible lifting cells inside the vehicle envelope, adjusting controllable telescoping struts by changing length from attach points on the keel and the outside envelope, and/or using variable pressure in air pressure beams installed in the outer envelope.

The large surface area to mass ratio of the ABL-RLV results in a slower and lower temperature descent than that of the space shuttle, for example. For example, a large ABL-RLV having 8 times the dry mass and 75 the cross sectional area of the space shuttle will experience skin temperatures of less than 800° C. during reentry. The same principle applies to smaller scale ABL-RLVs. Consequently, materials used for the outer covering of the flexible air envelope need not resist temperatures as high as those experienced by the space shuttle. Table 2 provides several examples of materials that can be used for various parts of the ABL-RLV, including materials that may be used for the outer surface of the flexible air envelope.

TABLE 2
Properties of Materials for Use in the ABL-RLV

| | Tensile | | Strength | |
|---|---|---|---|---|
| | Strength | | GPa/ | Temperature* |
| Material Name | (GPa) | g/cm³ | (g/cm³) | Celsius |
| | 3.5 | 1.75 | 2.00 | 450° C. |
| Carbon Fiber w/Ultra2000 | 3.5 | 1.75 | 2.00 | 1000° C. |
| Nextel | 3.3 | 4.1 | 0.80 | 1100° C. |
| Kevlar | 3.6 | 1.44 | 2.50 | 350° C. |
| Spectra 2000 | 3.5 | 0.97 | 3.61 | 180° C. |
| Zylon | 5.8 | 1.55 | 3.74 | 650° C. |
| Quartzel | 3.6 | 2.20 | 1.64 | 1050° C. |

What is claimed is:

1. An Air-Breathing Lung Reusable Launch Vehicle comprising:
a flexible air envelope having the shape of a lifting body and capable of storing air collected during flight,
at least one air-breathing engine comprising a by-pass flow thrust diverter capable of diverting outside air into the flexible air envelope, and
at least one fuel tank holding a liquefied or liquid fuel.

2. The Air-Breathing Lung Reusable Launch Vehicle of claim 1 further comprising:
a rigid keel attached to the flexible air envelope in an airtight manner.

3. The Air-Breathing Lung Reusable Launch Vehicle of claim 2 wherein the rigid keel comprises:
a heat resistant nose located at the leading edge of the vehicle,
thrust vectoring flaps capable of directing thrust generated by the at least one air-breathing engine,
an air inlet capable of conveying outside air to the at least one engine,
at least one flexible lifting cell, and
wherein:
the pressure within the flexible air envelope remains higher than the pressure outside the vehicle at all times.

4. The Air-Breathing Lung Reusable Launch Vehicle of claim 2 wherein:
the rigid keel extends from the nose of the vehicle along the bottom of the vehicle for at least 60% of the length of the vehicle.

5. The Air-Breathing Lung Reusable Launch Vehicle of claim 3 wherein:
the fuel is liquefied hydrogen and the lifting gas is hydrogen gas.

6. A method of achieving transatmospheric flight comprising:
storing air in a flexible air envelope during atmospheric flight for subsequent use as an oxidizer by air breathing engines above the atmosphere.

7. The method of claim 6 wherein air is diverted into the flexible air envelope by at least air-breathing engine comprising a by-pass flow thrust diverter capable of diverting outside air into the flexible air envelope.

8. The method of claim 7 wherein the airship comprises flexible lifting cells that can be filled with a lifting gas.

9. The method of claim 8 wherein lifting cells are situated within the flexible air envelope and, as the lung fills with air, lifting gas is vented from the lifting cells.

10. The method of claim 6 wherein the lung comprises a flexible air envelope attached to a rigid keel in an airtight manner to form a lifting body.
